(19) United States
(12) Patent Application Publication
(10) Pub. No.: US 2023/0129199 A1
(43) Pub. Date: Apr. 27, 2023

(54) METHOD OF COORDINATING ONE OR MORE MANEUVERS AMONG VEHICLES

(71) Applicants: Bayerische Motoren Werke Aktiengesellschaft, München (DE); Fraunhofer-Gesellschaft Zur Förderung Der Angewandten Förschung E.V., München (DE)

(72) Inventors: Bernhard HAEFNER, München (DE); Josef JIRU, München (DE); Karsten ROSCHER, München (DE)

(21) Appl. No.: 17/917,964

(22) PCT Filed: Apr. 9, 2020
(86) PCT No.: PCT/EP2020/060293

§ 371 Date: Oct. 10, 2022

(51) Int. Cl. B60W 60/00; G08G 1/16; G05D 1/02

(52) U.S. Cl. CPC B60W 60/001; G08G 1/162; G05D 1/0291; B60W 2556/65; G05D 2201/0213

(57) ABSTRACT

A method of coordinating one or more maneuvers among automated vehicles is presented. The method comprises: planning (21) a coordinated maneuver sequence that involves an initiating vehicle (HV) and a remote vehicle (RV, RV1, RV2, RV3, RV4); and transmitting (22) a request message (CQM) to the remote vehicle (RV, RV1, RV2, RV3, RV4), the request message (CQM) including information specifying the coordinated maneuver sequence.

This specification refers to a method of coordinating one or more maneuvers among vehicles as well as to computing devices being configured for executing such a method. In particular, this specification refers to aspects of a protocol for arbitrary complex interactions among Connected and Automated Vehicles (CAVs), an exemplary embodiment of which shall also be referred to as a Complex Vehicular Interactions Protocol (CVIP) in the following.

In the field of autonomous driving, it is widely accepted that automated vehicles will have to be connected so as to create mutual awareness and coordinate maneuvers. How this interaction among automated vehicles shall be achieved in detail is, however, still an open issue. Several new protocols are currently discussed for cooperative services such as changing lanes or overtaking, e.g., within the European Telecommunications Standards Institute (ETSI) and Society of Automotive Engineers (SAE). These communication protocols are usually specific to individual maneuvers or based on implicit assumptions on other vehicles' intentions.

Further, besides internet connectivity for infotainment use cases, direct communication among traffic participants, Vehicle-to-Everything (V2X), is already very close to becoming a reality. Even though this has been proclaimed for more than ten years, things have changed, recently. Standards regarding basic safety can be regarded as almost mature, and first Original Equipment Manufacturers (OEMs) start deploying basic V2X services in series production vehicles, despite not all questions having been answered, yet.

Attention has recently shifted from basic warning services to how vehicular communication can support cooperative and automated driving. Those so-called Day 2 or Day 3 services will change the way vehicles interact with each other [1], on urban and highway roads as well as on intersections [2], [3]. They use V2X to enable negotiations among vehicles and leverage distributed intelligence, further increasing safety and convenience. First standardization efforts of such advanced services have started in Europe [4] and the United States [5].

A lot of researchers started to investigate complex interactions, recently. For example, Burger et al. [7] defined a cooperative action to be willingly and knowingly executed with the intention to work towards a common goal, i.e. a joint optimum. They classify cooperation depending on exchanged information (information-based) and the optimization goal for a joint action (maneuver-based). In the highest stage, total utility is optimized by sharing state information, intentions, and individual utilities.

Generally, cooperative behavior protocols can be divided into implicit and explicit ones.

With implicit approaches, vehicles share intentions periodically and have to infer from the potentially changed intentions received from others, whether their proposal has been accepted or not [8]. For example, in IMAGinE [9], every vehicle periodically broadcasts its planned trajectory as beacon. If a trajectory update is to be initiated, a desired trajectory is sent, additionally. Other vehicles evaluate a change of their own planned trajectory in order to make the desired trajectory possible. Based on received updated plans, the initiating vehicle can judge whether it can change its planned trajectory or not. TransAID [10] adds the possibility of trajectory proposals by Road Side Units (RSUs) as traffic coordinators.

Approaches based on explicit coordination are conceptually different. The idea is that a vehicle's desired maneuver has to be explicitly committed to or acknowledged from relevant actors to be sure the proposal has been accepted. In [6], a lane change protocol is suggested. A Lane Change Request is broadcast, and answered via a unicast Lane Change Response. Based on the feedback, a suitable peer vehicle is selected which will make space for the initiator, announcing having finished this with a Lane Change Prepared message. Now the initiator changes lane without further communication.

Another way of explicit cooperation is the space-time reservation procedure [11]: a vehicle sends a request for some static or moving lane-level road space. Other vehicles will evaluate this in terms of inferred cost and send a commit message if they accept it. Vehicles not sending a commit message are either unwilling to participate or not able to take part in the negotiation; their behaviors have to be predicted based on an uncooperative movement model. Considering all received commits, the initiating vehicle will determine whether it is safe to enter the reserved road space and if yes do so, without further communication.

Franke et al. present a protocol where each vehicle announces possible maneuvers and associated costs, and an optimal subset of maneuvers is chosen for execution [12].

The mentioned approaches have certain limitations. In particular, most known protocols enable very specific maneuvers (e.g., lane changes), requiring adjustments for every new use case [6].

For implicit approaches, vehicles have to guess whether other vehicles understood the own proposal or are just coincidentally changing their trajectory. This may yield very conservative CAVs. Moreover, periodically broadcasting trajectories results in heavy bandwidth usage, unnecessary if no maneuver is to be performed. How a generation rule for such periodic beacons should look like is another unsolved issue [10].

Current explicit approaches are either very application-specific or based on road geometries. The former is suboptimal since each new maneuver would require a new message set. The latter is more general, but can only account for rather simple reservations of road space for the initiating vehicle.

A disadvantage common to all current explicit maneuver coordination approaches is that they support only a single initiator and feedback from others. Maneuvers where two or more participants jointly negotiate and perform certain actions are not supported.

To tackle this problem, Correa et al. [10] propose using infrastructure. They suggest a Maneuver Coordination Message via which RSUs can advise vehicles to follow certain trajectories. However, because they build upon intention beaconing, it is not possible to perform a truly joint maneuver among several vehicles, since no mechanism assures that either all or none of the addressed vehicles takes the action suggested by the infrastructure.

It is an object of the present invention to overcome or mitigate at least some of the mentioned shortcomings of solutions known in the art. For example, it is desirable to provide a method enabling maneuver coordination among vehicles in a flexible, efficient, and robust manner.

This object is solved by a method as well as by computing devices according to the independent claims. Preferred embodiments are the subject matter of the dependent claims.

It should be noted that additional features of a claim dependent on an independent claim may, without the features of the independent claim or in combination with a subset of the features of the independent claim, constitute a separate invention independent of the combination of all features of the independent claim, which may be the subject of an independent claim, a divisional application or a subsequent application. The same applies equally to technical teachings described in the description which may constitute an invention independent of the features of the independent claims.

As used in this specification, the term vehicle shall be understood in a broad sense. For example, the term vehicle includes passenger cars, busses, commercial vehicles, transport vehicles, drones, robots, motorboats, ships, agricultural vehicles, railway vehicles and others.

Further, the term vehicle may refer to automated or non-automated vehicles.

In addition, it should be noted that in accordance with some embodiments, certain method steps described in the following (e.g. steps concerning planning and/or evaluation of a coordinated maneuver sequence) may be performed by elements in connected infrastructure (e.g., Road Side Units, edge computing devices, backend servers, quasi stationary elements in fabrication plants, or others). Thus, the elements performing such steps need not necessarily be arranged in a vehicle. For example, the proposed method may involve one or more interactions between infrastructure components and/or interactions between an infrastructure component and one or more vehicles.

According to a first aspect of the invention, a method of coordinating one or more maneuvers among vehicles (in particular CAVs) is presented. The method comprises: planning a coordinated maneuver sequence that involves an initiating vehicle (sometimes also referred to as the “host vehicle” in the following) and a remote vehicle; and transmitting a request message to the remote vehicle, the request message including information specifying the coordinated maneuver sequence.

This is to say that the request message comprises a specific proposal for the remote vehicle to execute one or more actions (e.g. sub-maneuvers) within the specified coordinated maneuver sequence. Additionally, the request message may comprise one or more actions the host vehicle is planning to execute within the specified coordinated maneuver sequence. Those individual actions may be temporally independent of one another. Alternatively, temporal relations (e.g. concerning respective start or end times) between them may be expressed within the proposal.

The proposed method allows explicit joint maneuver negotiation, while still keeping general applicability. In other words, the method is not use case specific, but enables reuse and supports extensibility towards future maneuvers. For example, by including new fields in the request message (and possibly also in subsequent messages, as described below in connection with some embodiments), also future use cases can be easily realized.

The method may also be used for coordinating a plurality of maneuvers.

Each maneuver may comprise several actions, such as sub-maneuvers.

The coordinated maneuver sequence may comprise a plurality of individual actions, sub-maneuvers and/or maneuvers.

In the present context, coordination may refer to coordination of the planning of a coordinated maneuver sequence and optionally also to the coordination of an execution of the coordinated maneuver sequence.

It should be understood that in accordance with some embodiments, the method may involve a plurality of remote vehicles, such as at least two remote vehicles. Thus, in principle, the method allows coordinating complex maneuvers for arbitrary many participants.

For example an individual request message may be sent to each remote vehicle, wherein each remote vehicle may be addressed by means of a respective ID, such as a so-called station ID.

For example the initiating vehicle may issue such a request message after determining a need for a joint maneuver to one or several remote vehicle(s) as potential partner(s).

In accordance with some embodiments the request message may be transmitted directly or indirectly from the initiating vehicle to the remote vehicle(s).

For example, a wireless transmission path for the request message may extend between a transmitter of the initiating vehicle and a receiver of the remote vehicle (in particular, from the transmitter of the initiating vehicle to the receiver of the remote vehicle), wherein optionally one or more intermediate stations, such as base stations etc., may be additionally involved.

In an embodiment, the planning of the coordinated maneuver sequence is triggered or carried out by a computing device of the initiating vehicle. For example, at least some of data processing involved in the planning may be performed by such a computing device, which may be arranged in the initiating vehicle. For example, such a computing device may implement (at least a part of) what will be referred to as a “cooperation logic” further below.

It is also within the scope of the invention that the planning may be done, e.g., by one or more elements of connected infrastructure (such as a Road Side Unit, an edge computing device, a backend server, or the like).

For example, in an embodiment, some data processing involved in the planning may be at least partially executed on an external computing device, such as by means of an edge or cloud service and/or a remote server. For example, an edge computing platform besides the road can propose maneuvers. In such cases it may be provided that the planning of the coordinated maneuver sequence is at least triggered (i.e., initiated) by a computing device of the initiating vehicle.

Preferably, the planning of the coordinated maneuver sequence takes into account assumptions (or knowledge) on maneuver capabilities of the remote vehicle, e.g. with regard to its physical capabilities and vehicle dynamics. In other words, the proposed maneuvers may directly reflect assumptions (or knowledge) of the initiating vehicle on the physical capabilities and vehicle dynamics of other actors. For example, this may also refer to certain restrictions of the remote vehicle(s). Such assumptions or knowledge of the initial vehicle may be based, for example, on a protocol-based inquiry of values or status information, which may yield indications of (in)sufficient capacities, or the like. Such information may be conveyed by means of a response scheme explained below, for example.

Further, in accordance with some embodiments, the planning of the coordinated maneuver sequence may take into account current and/or future (predicted) Quality of Service parameters of communication (e.g., regarding latency, jitter, data rate, channel load, packet scheduling, etc.).

For example, the assumptions or the knowledge mentioned above may be based on an environment model and/or on a prediction model available to the initiating vehicle. Backend information available to the initiating vehicle may also be used as a basis for such assumptions or knowledge.

As regards the contents of the request message, in an embodiment, the request message may further express one or several information needs that the initiating vehicle requests to be fulfilled by the remote vehicle. In other words, in a request message that proposes a coordinated maneuver sequence, information needs can additionally be expressed that the initiating vehicle wants to be fulfilled by one or several remote vehicles. Thus, the method may also enable demand-based information exchanges based on the same set of messages as used for maneuver coordination. Hence, the proposed protocol may combine cooperative perception and cooperative maneuvering.

In an embodiment, the method further comprises the steps of: receiving the request message at the remote vehicle; and evaluating the information included in the request message as to whether the coordinated maneuver sequence is acceptable.

For example, the acceptability of the proposed coordinated maneuver sequence may depend on the feasibility according to the remote vehicle's own environment model or prediction model and/or on a willingness of the remote vehicle as evaluated, e.g., based on the remote vehicle's own path planning and/or driving strategy. Specifically, said evaluation may involve evaluating a cost functional reflecting several trajectory planning and/or maneuver planning criteria.

In an embodiment, the evaluation of the information included in the request message is triggered or carried out by a computing device of the initiating vehicle. For example, at least some of the data processing involved in the evaluation may be performed by such a computing device, which may be arranged in the remote vehicle. For example, such a computing device may implement (at least a part of) what will be referred to as a “cooperation logic” further below.

It is also within the scope of the invention that some data processing involved in the evaluation may be at least partially executed on an external computing device, such as by means of a cloud service and/or a remote server. In this case it may be provided that the evaluation of the information included in the request message is at least triggered (i.e., initiated) by a computing device of the remote vehicle.

As a further step, the method may comprise transmitting a response message to the initiating vehicle.

In accordance with some embodiments the response message may be transmitted directly or indirectly from the remote vehicle to the initiating vehicle.

For example, a wireless transmission path for the response message may thus extend between a transmitter of the remote vehicle and a receiver of the initiating vehicle (in particular, from the transmitter of the remote vehicle to the receiver of the initiating vehicle), wherein optionally one or more intermediate stations, such as base stations etc., may be additionally involved.

The response message indicates (explicitly or implicitly) whether the coordinated maneuver sequence is acceptable for the remote vehicle. Thus, the response message may convey a confirmation or a decline of the proposed coordinated maneuver sequence, the latter possibly in conjunction with a counter-proposal, as described in the following.

In an embodiment, the response message includes a counter-proposal for a coordinated maneuver sequence that is acceptable for the remote vehicle.

For example, in this case the method may further include a step of planning an adjusted coordinated maneuver sequence that is acceptable for the remote vehicle, wherein said planning may be carried out or triggered by the remote vehicle (such as by means of a computing device of the remote vehicle, which may, for example, implement a so-called cooperation logic).

The combination of the transmitted request(s) and the received response(s) may provide a clear picture to the initiating vehicles regarding the remote vehicles' willingness to participate.

In particular, by providing the response message as part of a protocol for a coordinating maneuver, willing participants of the coordinated maneuver may be determined via the responses received from the remote vehicles. Thus, for example, some known disadvantages [8] related to concepts involving group formation for complex maneuvers [13] may be avoided.

In an embodiment, the method further comprises, in response to the initiating vehicle receiving a response message indicating that the coordinated maneuver sequence is not acceptable for the remote vehicle: planning an adjusted coordinated maneuver sequence that involves the initiating vehicle and said remote vehicle and/or one or several other remote vehicle(s); and transmitting an updated request message (e.g. from the initiating vehicle) to the remote vehicle(s) involved in the adjusted coordinated maneuver sequence, wherein the updated request message includes information specifying the adjusted coordinated maneuver sequence.

Alternatively or additionally, the method may comprise, in response to the initiating vehicle receiving one or more affirmative response messages indicating that the (possibly already adjusted) coordinated maneuver sequence is acceptable for all involved remote vehicles: transmitting a maneuver status message to the involved remote vehicles, the maneuver status message indicating that the coordinated maneuver sequence is planned.

For example, in accordance with some embodiments, it may be provided that an iteration of (possibly updated) request messages and response messages shall be repeated until no changes are proposed and no errors are sent any more. This may be taken as sign for “convergence” of the maneuver coordination.

When convergence is reached, the initiating vehicle may send status message, with the agreed maneuvers, together with a maneuver status as “Planned” for each maneuver. In this way, every participating vehicle can be sure that all other involved vehicles also have agreed to a maneuver.

More generally, in accordance with some embodiments, the method may comprise transmitting one or more status messages between the vehicles involved in the (possibly already adjusted) coordinated maneuver sequence, wherein each status message indicates to the receiving end a respective status of the maneuvers of the coordinated maneuver sequence at the sending end.

Thus, the proposed method supports explicitly negotiating maneuvers between the involved vehicles while allowing monitoring the maneuver progress via status updates.

For example, besides a status “Planned” as mentioned already above, possible other status values which may be conveyed with the status message(s) are “InProgress”, “Finished”, and “Cancelled”.

For example, via such status messages, all involved vehicles may always know a current execution status of each participating actor.

In an embodiment, it is provided that the execution status of a specific action can only be changed by the actor performing this action. This may help to avoid inconsistencies.

For example, once the respective status for all maneuvers of the coordinated maneuver sequence has been set to Finished, the joint maneuver can be considered completed.

Further, it may be provided that every participating vehicle (i.e., the initiating vehicle and the remote vehicle(s)) may cancel the coordinated maneuver sequence by means of a status message. The interaction protocol may then take care of an orderly and consistent cancellation of the coordinated maneuver sequence.

Optionally, a suitable resend scheme may be implemented for the status messages so as to make sure that every status message reaches every participating actor (other than the sender of the status message). An exemplary resend scheme of this kind is described below in the detailed description of embodiments.

For example, the necessity of applying a resend scheme and its specific design may depend on and may possibly be adjusted in dependence on the reliability of a transmission channel (e.g., in case it is very unreliable, messages may be resent several times).

Further, in an embodiment, the maneuver status information included in the received status message is stored at the respective receiving end. In particular, it may be provided that upon reception of a first status message, every participating vehicle having received the status message stores the current status of all maneuvers of the coordinated maneuver sequence internally in order to keep track of the other actors' execution and to know when to trigger own ones.

In an embodiment, the method further comprises transmitting a feedback message in response to receiving a status message.

The feedback message may serve as an acknowledgment.

For example, the feedback message indicates reception of a status message and/or execution states of the maneuvers as buffered internally on the sending vehicle.

It is preferred that the reception of the status message is confirmed by means of a feedback message to ensure that every participating vehicle knows about the current status.

For example, it may be provided that the feedback message repeats the content of the received status message. Thus, it may be ensured that all participating vehicles have a synchronized status of all involved vehicle's execution states. Thus, for example, conflicts may be recognized and consistency may be ensured in case of transmission errors. In particular, this provides an efficient mechanism to prevent diverging internal execution states across actors, for example due to messages not received. It should be noted that functionally this goes beyond sending a simple ACK message.

In some embodiments, all feedback messages may be sent to all the other participating vehicles. Alternatively, it may be provided, for example, that feedback messages shall be sent at least to the sending vehicle of the to-be-confirmed status message (and possibly also to some or all of the other participating vehicles).

Further, in an embodiment, it is provided that status messages transmitted by a participating vehicle are synchronized with the actions carried out by said vehicle in the framework of the coordinated maneuver sequence. This is to say that, for example, in response to receiving, in a status message, a status after which the vehicle is supposed to start a certain action (i.e., a maneuver or part thereof, such as decelerating to a certain velocity), the vehicle acknowledges by sending a feedback message, starts the action and then sends a status message indicating the status InProgress for the respective action.

According to a second aspect of the invention, a computing device is configured for: planning a coordinated maneuver sequence that involves an initiating vehicle and a remote vehicle; and generating a request message addressed to the remote vehicle, the request message including information specifying the coordinated maneuver sequence.

In accordance with some embodiments, the computing device according to the second aspect may be configured for executing some or all of the steps of the method according to the first aspect as described above, in particular, insofar as the steps are carried out at or on behalf of the initiating vehicle are concerned.

Accordingly, in some embodiments, the computing device may be arranged in the initiating vehicle. In other embodiments, the computing device may be arranged external of the initiating vehicle.

A third aspect of the invention refers to a computing device being configured for: receiving a request message originating from an initiating vehicle, the request message including information specifying a coordinated maneuver sequence proposed to a remote vehicle; and evaluating the information included in the request message as to whether the coordinated maneuver sequence is acceptable for the remote vehicle.

In accordance with some embodiments, the computing device according to the third aspect may be configured for executing some or all of the steps of the method according to the first aspect as described above, in particular, insofar as the steps are carried out at or on behalf of the remote vehicle are concerned.

Accordingly, in some embodiments, the computing device may be arranged in the remote vehicle. In other embodiments, the computing device may be arranged external of the remote vehicle.

It should further be noted that in some embodiments a computing device according to the third aspect may be at the same time configured as a computing device according to the second aspect. In other words, the computing device may be configured for executing some or all of the steps of the method according to the first aspect as described above, namely steps that are carried out at or on behalf of the initiating vehicle and/or at or on behalf of the remote vehicle(s).

For example, a vehicle being equipped with such a computing device (or having access to such a computing device in case it is arranged external of the vehicle) may function as an initiating vehicle as well as a remote vehicle within the method of the first aspect of the invention.

In a fourth aspect, a computer program comprises instructions which, when the program is executed by a computing device, cause the computing device to carry out the steps as specified above.

In a fifth aspect, a computer-readable storage medium comprises instructions which, when executed by a computing device, cause the computing device to carry out the steps as specified above.

A sixth aspect refers to a data carrier signal carrying the computer program according to the fourth aspect.

In a further aspect, a method analogous to the method of the first aspect of the invention may be applied more generally to the task of coordination of actions between two or more agents.

Accordingly, a method of coordinating actions among automated vehicles, may comprise:
planning a coordinated action sequence that involves an initiating agent and a remote agent; and
transmitting a request message to the remote agent, the request message including information specifying the coordinated action sequence.

Optionally, further method steps in this context may be carried out analogously to some or all of the embodiments of the method according to the first aspect (e.g., evaluating the proposal, transmitting a response, negotiating the proposal, transmitting one or more status messages during an execution phase of the coordinated action sequence, transmitting feedback messages, etc.).

Corresponding computing devices, which are configured for carrying some or all of the steps of such a method of coordinating actions among agents may also be provided.

The same applies for a corresponding computer program, a corresponding computer-readable storage medium, and a corresponding data carrier signal.

For example, in some embodiments, one or more of the agents may be robots, such as industrial robots, which may be configured for executing certain actions, e.g., in an industrial production context. More generally, the agents may be machines or parts thereof.

Thus, the task of maneuver planning and execution, which is primarily described in this specification, can also be expanded to other coordination tasks like integration and process coordination, e.g. automatic integration of manually moved or replaced machineries in an industrial manufacturing plant.

Those skilled in the art will recognize additional features and advantages upon reading the following detailed description, and upon viewing the accompanying drawings.

Reference will now be made in detail to various embodiments, one or more examples of which are illustrated in the figures. Each example is provided by way of explanation, and is not meant as a limitation of the invention. For example, features illustrated or described as part of one embodiment can be used on or in conjunction with other embodiments to yield yet a further embodiment. It is intended that the present invention includes such modifications and variations. The examples are described using specific language which should not be construed as limiting the scope of the appended claims. The drawings are not scaled and are for illustrative purposes only. For clarity, the same elements or manufacturing steps have been designated by the same references in the different drawings if not stated otherwise.

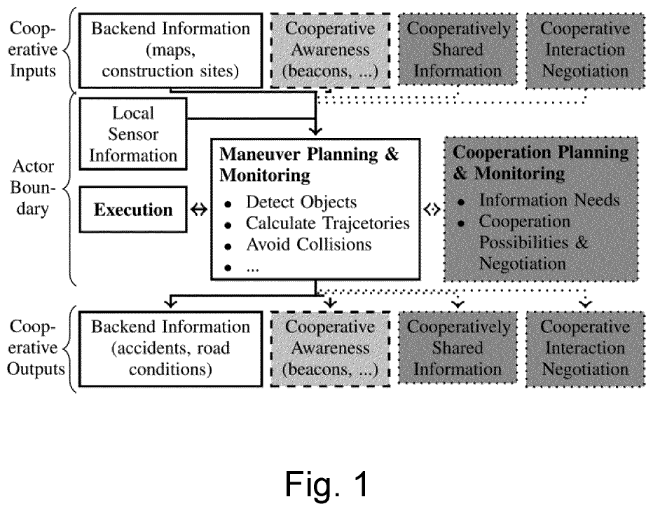

FIG. 1 schematically and exemplarily illustrates a model for complex interactions among vehicles showing an actor together with inputs and outputs in different stages of cooperation (Day 0-3).

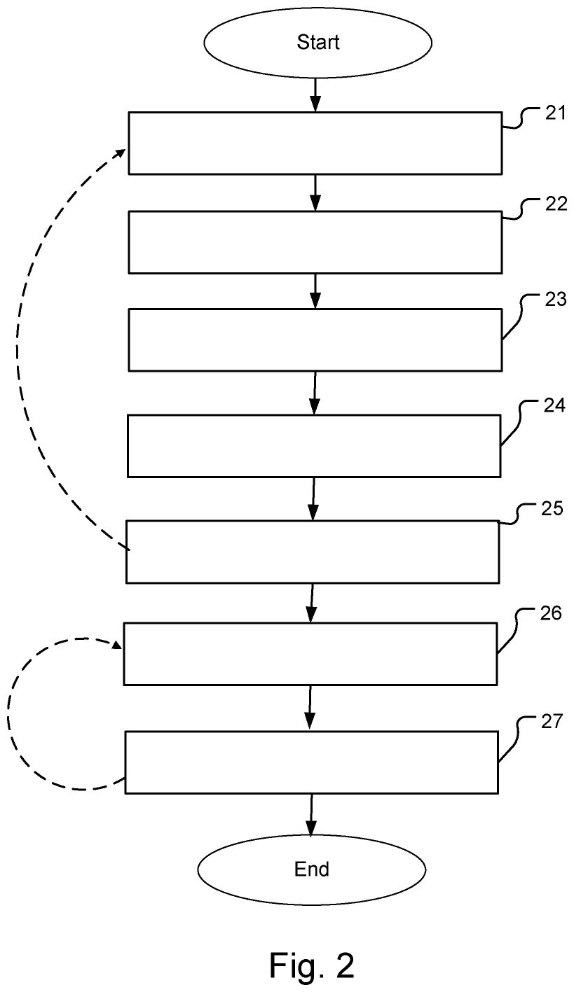

FIG. 2 schematically and exemplarily illustrates a sequence of method steps in accordance with one or more embodiments.

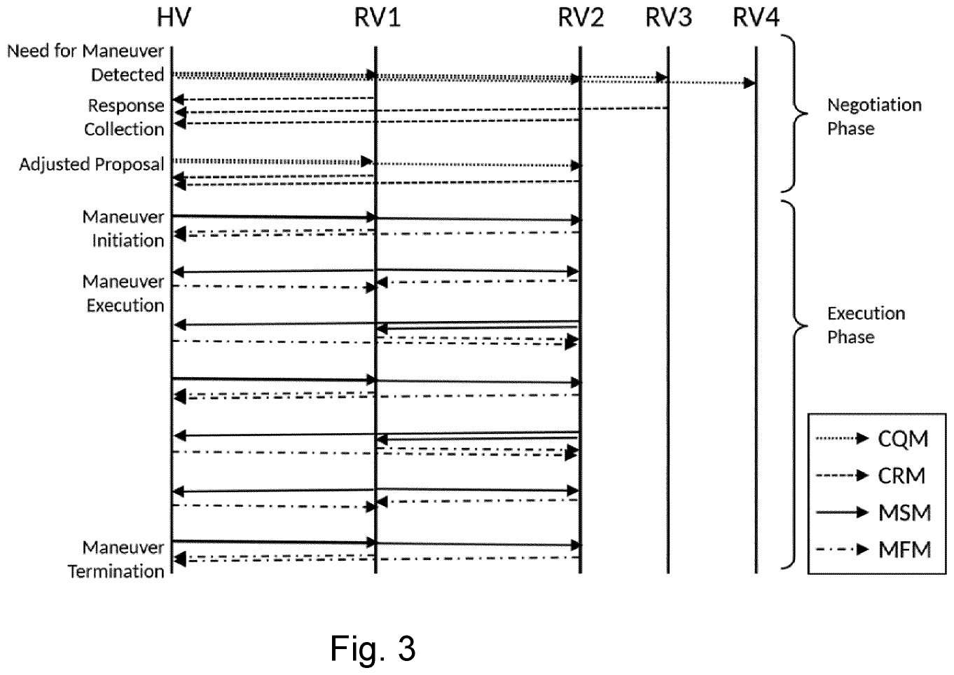

FIG. 3 schematically and exemplarily illustrates a message flow between a host vehicle and several remote vehicles in accordance with one or more embodiments.

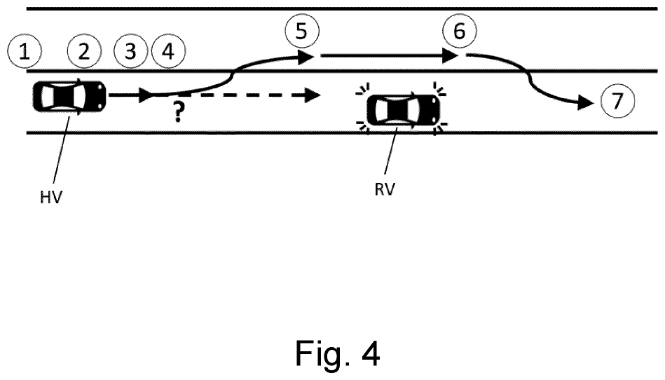

FIG. 4 is a schematic and exemplary use case illustration for a Stationary Vehicle Decision Assist (SVDA) scenario.

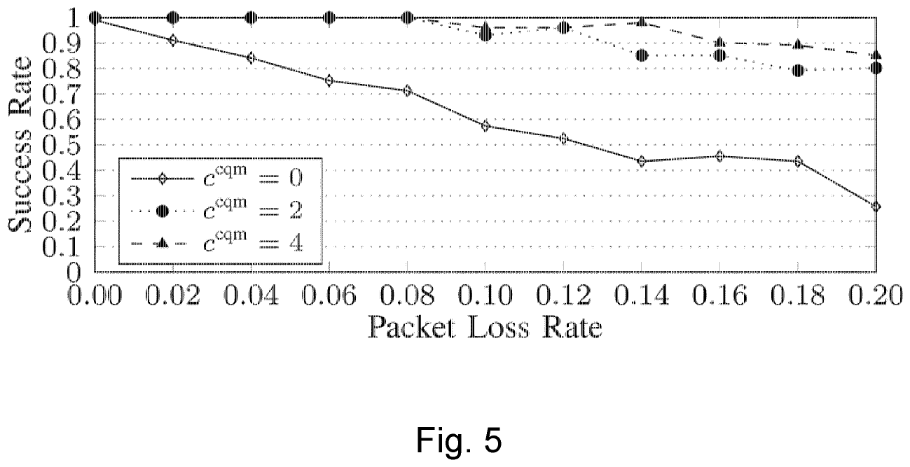

FIG. 5 shows a diagram of a ratio of successfully completed maneuvers vs. packet loss rate as simulated for a protocol flow in accordance with one or more embodiments.

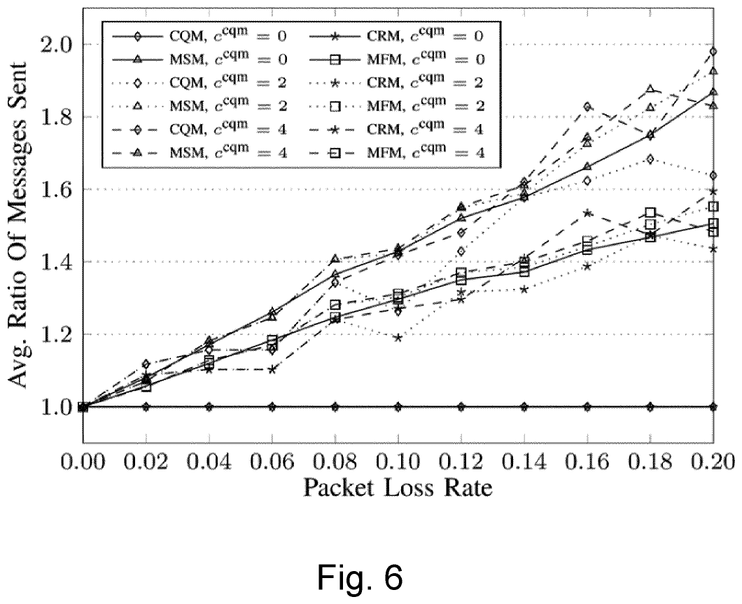

FIG. 6 shows a diagram of an average ratio of messages sent in successfully completed maneuvers vs. a packet loss rate for each of several message types, as simulated for an exemplary protocol flow in accordance with one or more embodiments.

In the following, exemplary embodiments involving complex interactions among CAVs will be described. For example, in accordance with some embodiments, complex interactions may be defined as message exchanges between two or more actors with at least three messages of which at least one depends on another. The rationale for this definition is as follows: clearly, a single vehicle cannot interact. Furthermore, even if simple interactions might exchange less than three messages, most cooperations should involve at least a request/proposal, a response/acceptance, and a decision.

The dependency requirement reflects that an actual interaction needs to happen. Later messages must differ in content or addressee if something in the earlier chain of messages changes. Exchange of periodic beacons broadcasted independent of the received inputs, e.g., about the sender state or perceived objects, are not complex interactions, since they do not depend on other actors' actions or messages.

The above definition of complex interactions includes different applications like maneuver cooperation or information sharing, and is mostly concerned about the underlying protocol. The thinking is that in a fully connected ecosystem, it may not be sensible to distinguish too many types of interactions, but rather generalize protocols towards applicability across a wide range of scenarios, as long as induced overhead allows. For example, a vehicle may need further information in order to start a cooperation proposal. It therefore may request information first (e.g., on objects perceived by the front vehicle), and then start a subsequent maneuver negotiation (e.g., about an overtake maneuver).

FIG. 1 shows an exemplary and schematic model for a functional split of interactions and the transition from co-existence to cooperation, regarding the inputs and outputs of an exemplary system. Solid/white elements depict entities that are present already in a so-called co-existence phase, dashed/light gray elements enable cooperative awareness, while dotted/dark gray ones are needed for a fully cooperative environment.

Especially the cooperation logic (“Cooperation Planning & Monitoring”) depicted schematically in FIG. 1 will generally be OEM-specific, meaning the host vehicle cannot rely on other vehicles taking decisions according to its own expectations. Here, explicitly sharing maneuver intentions and information needs makes it easier for other actors to process and decide on cooperation. This is another advantage of a protocol that allows for the host vehicle to send a cooperation proposal to one or more remote vehicles so as to enter in a maneuver negotiation.

In the context of an exemplary embodiment to be described in the following, which shall be referred to as Complex Vehicular Interactions Protocol (CVIP), Cooperative Awareness Message (CAM) or Basic Safety Message (BSM) beacons are considered as given. They are utilized to identify potential maneuver partners in an Awareness Phase, before the actual interaction involving a Negotiation and an Execution Phase starts. Additional information needed should be exchanged via dedicated messages. Here, only joint maneuvers performed by automated vehicles are considered. Automated vehicles are able to share information about intentions, unlike manually-driven vehicles that can only measure their current status without knowing the driver's next action.

Vehicles have to be able to estimate others' dynamics to make reasonable maneuver proposals. In case a proposed maneuver is not possible for another vehicle, it can respond accordingly. As it is undecidable on protocol layer whether the content of a received message, e.g., a maneuver proposal, is realistic and feasible, higher layers have to evaluate incoming proposals. This task can be performed by the “Cooperation Planning & Monitoring” unit in FIG. 1.

Regarding security, it is assumed for the present embodiment that messages are signed and interactions are thus secured. This will potentially increase message sizes compared to the ones analyzed in this specification (see further below). Security of the communication as well as of the interaction itself is important, but since ways like credentials exist that take care of preventing certain malicious actions [14], a more detailed security analysis is deferred to future work.

The guiding principles of the Complex Vehicular Interactions Protocol (CVIP) are as follows:

At first, a suitable amount of acknowledgements is considered necessary, since actors need to know whether others have heard, understood, and agreed to a proposed interaction. In the CVIP protocol, the execution status of a specific action can only be changed by the actor performing this action, in order to avoid inconsistencies.

Secondly, even if some entity needs to express the initial request for a maneuver, the decisions on participation can only come from the actors themselves in a distributed way. Actors have to be able to abort maneuvers at any given point in time, for example if own safety is at risk.

In preferred embodiments of CVIP, cascading of requests (cf. [8]) is not enabled, since this would considerably increase delays before a maneuver can be executed [11]. Cascading means that a request of vehicle A to vehicle B induces further requests from vehicle B to others in order to be able to accept vehicle A's request.

In accordance with the guiding principles outlined above, a preferred embodiment of a method of involves the following steps, which are schematically illustrated in FIG. 2:
planning 21 a coordinated maneuver sequence that involves an initiating vehicle and a remote vehicle;
transmitting 22 a request message (CQM) to the remote vehicle, the request message (CQM) including information specifying the coordinated maneuver sequence;
receiving 23 the request message (CQM) at the remote vehicle;
evaluating 24 the information included in the request message as to whether the coordinated maneuver sequence is acceptable; and
transmitting 25 a response message (CRM) to the initiating vehicle, wherein the response message (CRM) indicates whether the coordinated maneuver sequence is acceptable for the remote vehicle.

In addition, the method may comprise, in response to the initiating vehicle receiving one or more affirmative response messages indicating that the coordinated maneuver sequence is acceptable for all involved remote vehicles:
transmitting 26 a maneuver status message (MSM) to the involved remote vehicles, the maneuver status message indicating that the coordinated maneuver sequence is planned.

More generally, the method may comprise:
transmitting 26 one or more status messages (MSM) between the vehicles involved in the coordinated maneuver sequence, each status message (MSM) indicating to the receiving end a respective status of the maneuvers of the coordinated maneuver sequence at the sending end.

The method may further comprise:
transmitting 27 a feedback message (MFM) in response to receiving a status message (MSM).

Specifically, the CVIP protocol described herein as an exemplary embodiment is designed to involve the following four types of messages: Cooperative Request Message (CQM), Cooperative Response Message (CRM), Maneuver Status Message (MSM), and Maneuver Feedback Message (MFM), as depicted in FIG. 3.

It should be noted that the transmission of the CQM as illustrated in FIG. 3 corresponds to step 22 in FIG. 2. Likewise, the transmission of the CRM corresponds to step 25. The transmission of an MSM corresponds to step 26. The transmission of the MFM corresponds to step 27.

A dashed loop in FIG. 2 indicates that steps 26 and 27 may be performed repeatedly during the negotiation and execution of a coordinated maneuver.

Another dashed loop in FIG. 2 illustrates that in the case of a negative response message or a response message comprising a counter-proposal (step 25), the method may continue with another (re-)planning step 21.

Exemplary sizes for specific message elements as described in the following can be found in Table I.

TABLE I
EXEMPLARY SIZE RANGES FOR THE PROTOCOL
CONSTITUENTS MENTIONED IN THE TEXT.

| | Element | | | | | | | | | | | | | |
|---|---|---|---|---|---|---|---|---|---|---|---|---|---|---|
| | | | I^{Q} | | | | I^{R} | M | | | | | | |
| Sub-element | G | S | i_{iqc} | i_{dest} | θ | T^{Q} | V | i_{mc} | iₚₖₜ | tₛₜₐᵣₜ | τ | T^{m} | S^{m} | P^{m} |
| Size [B] | 16 | 46 | 4 | 4 | 4 | 4 | 1-100 | 4 | 4 | 4 | 4 | 4 | 4 | 1-500 |

Referring to FIG. 4, it is explained in the following how the CVIP may be applied to a sample scenario involving a complex interaction named Stationary Vehicle Decision Assist (SVDA).

The SVDA scenario works as follows, cf. FIG. 4: A stationary remote vehicle RV is located in front of a driving host vehicle HV. After becoming aware of the situation, in order to evaluate whether it is worth the risk of overtaking, the on-coming host vehicle HV inquires about the estimated duration of stay of the stationary vehicle (stage “1” in FIG. 4). If the duration is below a threshold or not known, the on-coming host vehicle HV proposes to overtake, while the stationary remote vehicle RV should stay stationary (stage “2” in FIG. 4). Both vehicles agree and the overtake is executed.

In the following, reference will be made to both FIG. 3 and FIG. 4 and, in particular with the initiating vehicle HV and the remote vehicles RV, RV1, RV2, RV3, RV4 referenced therein.

In general, after determining a need for information or joint maneuver, some vehicle issues a CQM to potential partners. Its content can be depicted as tuple

CQM [symbol] (G,S, [symbol] ^{Q}, [symbol] ).

G contains basic information: protocol version, message ID i_{msg}, the initiating vehicle's station ID iₛ, generation time stamp t_{gen}, and a sequence number n_{seq}. S contains basic status information, mainly the ego GPS position for reference and an Instance ID. Those can be used for referencing in subsequent messages.

[symbol]

^{Q}=(I₁^{Q}, . . . ,Iₖ^{Q}) and [symbol] =(M₁, . . . ,Mₗ)

are containers for information requests and maneuvers, respectively, with k+l≥1.

Each I^{Q} contains an Information Request Container ID i_{iqc}=1, k for referencing, a destination station (vehicle) ID i_{dest} that should provide the information, the type of requested information T^{Q} as well as the update interval e in which the information is requested. In the SVDA scenario, this could be the estimated duration in the current mobility state (i.e., with velocity zero) with θ=−1 for one-time information.

The elements M are Maneuver Containers describing the foreseen joint actions, each containing a container ID i_{mc}, a destination station ID i_{dest} that should perform the maneuver, the maneuver type T^{m} and related parameters P^{m}. By setting i_{dest} appropriately, even higher-authority parties like RSUs or emergency vehicles could propose maneuvers in which they themselves do not participate actively.

Via T^{m} and P^{m}, maneuvers could be described as standardized names, parametrized functions, or also via trajectories. Those proposed maneuvers directly reflect assumptions on the physical capabilities and vehicle dynamics of other actors. A start time tₛₜₐᵣₜ—absolute or relative to another maneuver container—as well as the expected maneuver duration τ can also be included, if necessary.

In the SVDA scenario of FIG. 4, for example, one container M could be provided per vehicle, stating T^{m} for the initiating vehicle as overtake, and for the stationary vehicle as remain in current mobility state, both with tₛₜₐᵣₜ=0 and i equal to the expected duration of the maneuver.

In principle, also a more fine-grained statement of T^{m}'s may make sense, e.g., having three containers for the host vehicle HV—lane change, acceleration, lane change, along with relative start times to ensure a common understanding of the order of execution.

After reception of the CQM, other vehicles RV, RV1, RV2, RV3, RV4 evaluate the included information in their Cooperation Logic. They respond with a CRM defined as

CRM [symbol] (G,S, [symbol] ^{R}, [symbol] ).

While G and S contain the same types of sub-elements as in the CQM (i.e. updated t_{gen} etc.),

[symbol]

^{R}=(I₁^{R}, . . . ,Iₖ^{R})

are now Information Response Containers containing a referenced i_{iqc}, along with requested values V or an error. The vehicle can also state when a given T^{Q} was not understood or is not available.

The maneuver containers M now include a packet ID iₚₖₜ, based on iₛ and n_{seq} of the original CQM for stating references. Besides, a maneuver status S^{m} set to Planned or a respective error status is contained. If needed, updated values for tₛₜₐᵣₜ or τ can be given. The combination of request and received responses gives a clear picture to the initiator on the others' willingness to participate.

This iteration of CQM and CRM will be repeated until no changes are proposed and no errors are sent any more. This is the sign for convergence and every participating vehicle HV, RV, RV1, RV2 can be sure that all others also have agreed to a maneuver.

As depicted in FIG. 3, CAVs not implementing the protocol will not send a CRM (RV4). Vehicles that implement the protocol, but that either do not implement some of the requested T^{Q} or T^{m}, or that cannot fulfill requirements from the CQM, will send a response stating this (RV3). The initiating vehicle HV then updates the proposal according to the feedback and sends a new CQM involving only willing, capable, and necessary vehicles.

After convergence, the initiating vehicle HV will send an MSM

MSM [symbol] (G,S, [symbol] ),

with the agreed maneuvers in M, together with a maneuver status S^{m} as Planned for each container in M (stage “3” in FIG. 4). Other possible status values are InProgress, Finished, and Cancelled. Via those status, all vehicles will always know the execution status of each participating actor.

Upon reception of this first MSM, every vehicle has to store the current status of all l maneuvers internally in order to keep track of the other actors' execution and to know when to trigger own ones.

In order to inform the sender of the MSM that all participating vehicles have received the MSM and to make sure all participators' internal state directories are synchronized, an MFM is sent as acknowledgement, which can be described by

MFM [symbol] (G,S, [symbol] )

The MFM repeats the content of the MSM just received. While this may consume a considerable amount of the overall necessary bandwidth, it provides an efficient mechanism to prevent diverging internal execution states across actors, for example due to messages not received. For example, when diverging states for maneuver container M_{l′} are detected from the received MSMs and MFMs, the vehicle executing M_{l′} can send a clarifying MSM containing the currently correct execution state.

Whenever subsequently an actor changes its maneuver execution state—the sequence is known via a consistent use of the tₛₜₐᵣₜ and τ—it will send an MSM with the updated status to let every other vehicle know that it entered a new state (e.g., stages “4”/“6” in FIG. 4 where Lane Change has switched to inProgress, or at stages “5”/“7” in FIG. 4 where it is Finished). Once all maneuvers' status has been set to Finished, the joint maneuver is completed.

As the reception of messages is essential for synchronized state transitions among the vehicles, a resend mechanism based on a timeout may optionally be implemented. Thus, for example, it may be provided that if a CQM is dropped and thus no CRMs are received, the initiator resends its CQM after t_{wait}^{cqm} up to c^{cqm} times. If a CRM is dropped, then the vehicle has to be regarded uncooperative. In case an MSM is dropped, no MFMs are received at all and the message is thus resent after t_{wait}^{msm}, at most c^{msm} times.

In case of missing MFMs, the respective MSM is also resent after a timeout of t_{wait}^{msm}, in order to ensure synchronized state updates. If MFMs are missing after c^{msm} retries, the maneuver will be cancelled.

The timeouts and maximum resends may be adjusted for example based on different application scenarios, driving conditions, or traffic with surrounding vehicles potentially shadowing signals.

Since the requirements for different use cases may differ substantially, specific message contents (such as the number and type of containers, which information is transmitted, etc.) can be adjusted according to the respective needs. This gives CVIP the flexibility to support different scenarios without the need to define specialized messages. New scenarios are enabled easily by augmenting the set of defined values for T^{Q}, T^{m}, P^{m} or adding new fields.

The information in Table I above together with the analysis of simulations presented in the following show that message sizes currently would not exceed a few hundred Bytes. This means that today's vehicular communication technologies like ITS-G5 or LTE-V2X can easily support this extensibility.

Next, an evaluation of numerical experiments is presented. In order to show the general applicability of CVIP, the evaluation setting has been abstracted from specific applications. Instead, the following questions shall be answered via a set of simulations of the protocol flow:
Is the protocol scalable with respect to the number of nodes participating in a complex interaction?
Is the protocol feasible, i.e. is the message size constrained within sensible limits, even for high k, l?
Is the protocol robust, i.e. is it able to cope with lost packets?

To this end, a simple simulation scenario is considered: a set of N static vehicle nodes is placed on a straight lane in the simulation area. An initiating node sends the first CQM to all other nodes. As the details of the logic deciding on incoming cooperation requests are not at the center of the present investigation, all vehicles send a CRM with positive feedback. In reality, the higher-level cooperation logic would have to evaluate incoming CQMs' feasibility. From then, a simple maneuver is performed as described in Algorithm 1: one node after the other starts their maneuver of duration τ. With this setup, scalability regarding N and l, as well as the robustness can be evaluated by inserting packet losses with probability p_{drop}.

Algorithm 1 Sample application on node j.

| Input: MSM from node j − 1 with S^{m} = inProgress | |
|---|---|
| 1: | Send MFM, then wait for tₛₜₐᵣₜ |
| 2: | Send MSM, setting Mⱼ's S^{m} to inProgress |
| 3: | Wait for τ |
| 4: | Send MSM, setting Mⱼ's S^{m} to Finished |

All simulations have been performed using the Intelligent Transport System (ITS) framework ezCar2X for connected applications [15] in combination with the simulators SUMO and ns-3. For significant results, 100 simulation runs were performed for each parameter set described later.

The number of messages exchanged in one interaction can be formalized depending on the number of nodes N, of negotiation rounds v, and of maneuver containers l as

n_{msgs}^{cvip}=v+v·(N−1)+2·l+2·(N−1)·l. (1)

The factor 2 is because an MSM with status inProgress and Finished will be sent for each of the l maneuver containers, respectively, and each of them will be confirmed via MFMs by the N−1 other actors. It can be easily seen that

n_{msgs}^{cvip}= [symbol] (N·(v+2l)).

In contrast, the number of messages transmitted with frequency f in beaconing-based approaches for intention sharing,

n_{msgs}^{beac}=f·Θ·N, (2)

is dependent on the overall maneuver execution time Θ. For a reasonable set of values, e.g., N=10, v=1, 1=20, f=5 Hz, and Θ=10s, CVIP reduces the number of exchanged messages by almost 20%. This reduction is all the more significant as beacons are foreseen to be used even in times no maneuver is executed, as the whole concept of implicit maneuver negotiation is based on this periodic broadcast of intentions. With CVIP, messages are only exchanged if there is a need to. For a pure information exchange (i.e., l=0, k>0, v≥1), only very few messages will be sent, exactly satisfying information needs of the requesting vehicle. The size of the involved messages increases only linearly with the numbers k and l of included containers and, as Table I shows, the size of each I^{Q}, I^{R}, and M is relatively small. Via serialization techniques the overall sent message size can be further reduced. For example, for MFMs with l=7, the sent message size was on average 137 Byte, while the message size within the source code was 203 Bytes.

In a simulation, even for l=7, the overall message size did never exceed 225 Byte, transmitting all essential elements of a maneuver container. Even for today's technologies like ITSG5 or LTE-V2X, this makes our protocol feasible. For future use cases, there is still space to include additional fields, e.g., in P^{m}, without message sizes becoming infeasible. This also paves the way for more complex maneuver descriptions.

By introducing packet losses with probability p_{drop}, it was investigated how robust the protocol is towards transmission outages, even with the basic resend mechanism. For evaluation, maneuvers are counted as successfully completed if the last MSM containing all maneuver status set to Finished was sent and received. The ratio of successful maneuvers to all maneuvers is called success rate. If a single CRM is dropped, the maneuver will not be successful, since the initiating node cannot find out that one CRM is missing. Depending on the application, the initiating vehicle may thus choose to send several CQMs in order to minimize the probability that CRMs get lost. As FIG. 5 shows, this significantly improves the success rate, reaching 0.8 even for p_{drop}=0.2 for c^{cqm}=2.

FIG. 6 shows for scenarios with N=3 and one maneuver per vehicle, that the number of messages that need to be exchanged increases with p_{drop}, the base line case being p_{drop}=0. But even for p_{drop}=0.2, not even twice as many messages will be sent. In general, CQMs are sent relatively more often than CRMs, since a vehicle has to resend them for a lost CQM as well as for a lost CRM. The same holds for comparing MSMs and MFMs.

The analysis presented in the above shows that CVIP is feasible for complex interactions. In particular, the simulation shows that current technologies are sufficient to enable complex interactions. New communication technologies like 5G-V2X may support further use cases, e.g., by enabling unicast or bigger message sizes in order to include very data-intensive information V or maneuver parameters P^{m}.

With the above range of variations and applications in mind, it should be understood that the present invention is not limited by the foregoing description, nor is it limited by the accompanying drawings. Instead, the present invention is limited only by the appended claims and their legal equivalents.

### REFERENCES

[1] K. Sjoberg, P. Andres, T. Buburuzan, and A. Brakemeier, “Cooperative Intelligent Transport Systems in Europe: Current Deployment Status and Outlook,” IEEE Vehicular Technology Magazine, vol. 12, no. 2, pp. 89— 97, 2017.
[2] L. Chen and C. Englund, “Cooperative Intersection Management: A Survey,” IEEE Transactions on Intelligent Transportation Systems, vol. 17, no. 2, pp. 570-586, 2016.
[3] J. Rios-Torres and A. A. Malikopoulos, “A Survey on the Coordination of Connected and Automated Vehicles at Intersections and Merging at Highway On-Ramps,” IEEE Transactions on Intelligent Transportation Systems, vol. 18, no. 5, pp. 1066-1077, 2017.
[4] Intelligent Transport Systems (ITS); Vehicular Communication; Informative Report for the Maneuver Coordination Service, ETSI TR 103 578 V0.0.4 (2019-11), (Draft).
[5] Application Protocol and Requirements for Maneuver Sharing and Coordinating Service, SAE J3186 (Draft).
[6] L. Hobert, A. Festag, I. Llatser, L. Altomare, F. Visintainer, and A. Kovacs, “Enhancements of V2X Communication in Support of Cooperative Autonomous Driving,” IEEE Communications Magazine, vol. 53, no. 12, pp. 64-70, 2015.
[7] C. Burger, P. F. Orzechowski, 0. S. Tas, and C. Stiller, “Rating Cooperative Driving: A Scheme for Behavior Assessment,” in IEEE International Conference on Intelligent Transportation Systems (ITSC), 2018, pp. 1-6.
[8] B. Lehmann, H. J. Gunther, and L. Wolf, “A Generic Approach Towards Maneuver Coordination for Automated Vehicles,” in IEEE Conference on Intelligent Transportation Systems, Proceedings, ITSC, 2018, pp. 3333-3339.
[9] I. Llatser, T. Michalke, M. Dolgov, F. Wildschütte, and H. Fuchs, “Cooperative Automated Driving Use Cases for 5G V2X Communication,” in IEEE 5G World Forum (5GWF), 2019, pp. 120-125.
[10] A. Correa, R. Alms, J. Gozalvez, M. Sepulcre, M. Rondinone, R. Blokpoel, L. Lucken, and G. Thandavarayan, “Infrastructure Support for Cooperative Maneuvers in Connected and Automated Driving,” in IEEE Intelligent Vehicles Symposium, 2019, pp. 20-25.
[11] D. Heil, R. Lattarulo, J. Perez, T. Hesse, and F. Köster, “Negotiation of Cooperative Maneuvers for Automated Vehicles: Experimental Results,” in IEEE International Conference on Intelligent Transportation Systems (ITSC), 2019, pp. 1545-1551.
[12] K. Franke, M. During, R. Balaghiasefi, M. Gonter, K. Lemmer, and F. Kücükay, “A Reference Architecture for CISS/CDAS within the Field of Cooperative Driving,” in IEEE International Conference on Connected Vehicles and Expo (ICCVE), 2014, pp. 357-363.
[13] C. Frese, J. Beyerer, and P. Zimmer, “Cooperation of Cars and Formation of Cooperative Groups,” in IEEE Intelligent Vehicles Symposium, Proceedings, 2007, pp. 227-232.
[14] B. Brecht, D. Therriault, A. Weimerskirch, W. Whyte, V. Kumar, T. Hehn, and R. Goudy, “A Security Credential Management System for V2X Communications,” IEEE Transactions on Intelligent Transportation Systems, vol. 19, no. 12, pp. 3850-3871, 2018.
[15] K. Roscher, S. Bittl, A. A. Gonzalez, M. Myrtus, and J. Jiru, “ezCar2X: Rapid-Prototyping of Communication Technologies and Cooperative ITS Applications on Real Targets and Inside Simulation Environments,” in 11th Conference Wireless Communication and Information, 2014, pp. 51-62.

1. A method of coordinating one or more maneuvers among vehicles, the method comprising:
planning a coordinated maneuver sequence that involves an initiating vehicle and a remote vehicle; and
transmitting a request message to the remote vehicle, the request message including information specifying the coordinated maneuver sequence.

2. The method of claim 1, characterized in that the planning takes into account assumptions or knowledge on maneuver capabilities of the remote vehicle.

3. The method of claim 1, characterized in that the method further comprises:
receiving the request message at the remote vehicle; and
evaluating the information included in the request message as to whether the coordinated maneuver sequence is acceptable.

4. The method of claim 1, characterized in that the method further comprises transmitting a response message to the initiating vehicle, wherein the response message indicates whether the coordinated maneuver sequence is acceptable for the remote vehicle.

5. The method of claim 4, characterized in that the response message includes a counter-proposal indicating a coordinated maneuver sequence that is acceptable for the remote vehicle.

6. The method of claim 4, characterized in that the method further comprises, in response to the initiating vehicle receiving a response message indicating that the coordinated maneuver sequence is not acceptable for the remote vehicle:
planning an adjusted coordinated maneuver sequence that involves the initiating vehicle and said remote vehicle and/or one or several other remote vehicle(s); and
transmitting an updated request message to the remote vehicle(s) involved in the adjusted coordinated maneuver sequence, the updated request message including information specifying the adjusted coordinated maneuver sequence.

7. The method of claim 4, characterized in that the method further comprises, in response to the initiating vehicle receiving one or more affirmative response messages indicating that the coordinated maneuver sequence is acceptable for all involved remote vehicle(s):
transmitting a maneuver status message to the involved remote vehicles, the maneuver status message indicating that the coordinated maneuver sequence is planned.

8. The method of claim 1, characterized in that the method further comprises:
transmitting one or more status messages between the vehicles involved in the coordinated maneuver sequence, each status message indicating to the receiving end a respective status of the maneuvers of the coordinated maneuver sequence at the sending end.

9. The method of claim 7, characterized in that the method further comprises transmitting a feedback message in response to receiving a status message.

10. The method of claim 9, characterized in that the feedback message repeats the content of the received status message.

11. A computing device being configured for
planning a coordinated maneuver sequence that involves an initiating vehicle and a remote vehicle; and
generating a request message addressed to the remote vehicle, the request message including information specifying the coordinated maneuver sequence.

12. A computing device being configured for
receiving a request message originating from an initiating vehicle, the request message including information specifying a coordinated maneuver sequence proposed to a remote vehicle;
evaluating the information included in the request message as to whether the coordinated maneuver sequence is acceptable for the remote vehicle.

13. A computer program comprising instructions which, when the program is executed by a computing device, cause the computing device to carry out the steps as specified in claim 1.

14. A computer-readable storage medium comprising instructions which, when executed by a computing device, cause the computing device to carry out the steps as specified in claim 1.

15. A data carrier signal carrying the computer program of claim 13.
